(19) United States
(12) Patent Application Publication
(10) Pub. No.: US 2025/0211131 A1
(43) Pub. Date: Jun. 26, 2025

(54) INVERTER CIRCUIT WITH TWO SERIALLY CONNECTED AND ALTERNATING TRANSFORMERS AND INVERTER EQUIPMENT

(71) Applicant: Foshan Shunde Guanyuda Power Supply Co., Ltd., Foshan (CN)

(72) Inventors: Shan JIANG, Foshan (CN); William Chen, Foshan (CN)

(73) Assignee: Foshan Shunde Guanyuda Power Supply Co., Ltd., Foshan (CN)

(21) Appl. No.: 18/818,495

(22) Filed: Aug. 28, 2024

(30) Foreign Application Priority Data
Dec. 21, 2023 (CN) 202311781753.6

(51) Int. Cl. H02M 1/00; H02M 7/5387

(52) U.S. Cl. CPC H02M 7/4807; H02M 7/5387; H02M 1/0048

(57) ABSTRACT

Some embodiments of the disclosure provide an inverter circuit. In some examples, the inverter circuit includes an H-bridge circuit, a magnet oscillator circuit, a sampling control circuit and a load circuit. The magnet oscillator circuit includes a first transformer and a second transformer. A first output end of the H-bridge circuit is connected with a first end of the first transformer. A second end of the first transformer is connected with a first end of the second transformer. A second end of the second transformer is connected with a second output end of the H-bridge circuit. A third end of the first transformer is connected with a first end of the load circuit. A fourth end of the first transformer is connected with a fourth end of the second transformer. A third end of the second transformer is connected with a second end of the load circuit.

### CROSS REFERENCE TO RELATED APPLICATIONS

This application claims priority to Chinese Patent Application No. 202311781753.6, filed on Dec. 21, 2023, the disclosure of which is incorporated by reference herein in its entirety.

### FIELD OF THE DISCLOSURE

The disclosure relates generally to the field of circuits. More specifically, the disclosure relates to inverter circuits with two serially connected and alternating transformers and inverter equipment.

### BACKGROUND

All kinds of existing power supplies, such as batteries, dry batteries and solar cells, are direct-current power supplies. When these power supplies are needed to supply power to alternating-current loads, inverter circuits are needed. Under the action of the control circuit and the H-bridge circuit, the inverter circuit converts direct current output from the direct-current power supply into alternating current with adjustable frequency and voltage to be output, so that the power supply requirement of alternating-current loads is met. In related technologies, the H-bridge circuit drives a single high-frequency transformer with the LLC quasi-resonant circuit generally to achieve the inversion function. However, because there is an additional inductor, the inductor has energy loss, and then the power transfer efficiency and transmission power are affected.

### SUMMARY

The following presents a simplified summary of the invention in order to provide a basic understanding of some aspects of the invention. This summary is not an extensive overview of the invention. It is not intended to identify critical elements or to delineate the scope of the invention. Its sole purpose is to present some concepts of the invention in a simplified form as a prelude to the more detailed description that is presented elsewhere.

The present disclosure provides an inverter circuit with two serially connected and alternating transformers to solve the problem that the existing inverter circuit is low in power transmission efficiency and low in transmission power.

On one hand, the embodiment of the present disclosure provides an inverter circuit with two serially connected and alternating transformers. The inverter circuit includes an H-bridge circuit, a magnet oscillator circuit, a sampling control circuit and a load circuit. The magnet oscillator circuit includes a first transformer and a second transformer. A power end of the H-bridge circuit is connected to a positive electrode of a direct-current power supply, and a ground terminal of the H-bridge circuit is connected to a negative electrode of the direct-current power supply. A first output end of the H-bridge circuit is connected with a first end of the first transformer. A second end of the first transformer is connected with a first end of the second transformer. A second end of the second transformer is connected with a second output end of the H-bridge circuit. A third end of the first transformer is connected with a first end of the load circuit. A fourth end of the first transformer is connected with a fourth end of the second transformer. A third end of the second transformer is connected with a second end of the load circuit. The fourth end of the second transformer is connected with a third end of the load circuit. The sampling control circuit is respectively connected with the H-bridge circuit and the load circuit, and is configured to drive the H-bridge circuit and the load circuit, so that the first transformer and the second transformer are alternately in a forward and a flyback states respectively, and alternating current is output between the first output electrode and the second output electrode of the load circuit.

In an embodiment, the magnet oscillator circuit also includes a resonant capacitor serially connected with the first transformer and the second transformer. The resonant capacitor consists of x target capacitors connected in parallel, x is an integral number of greater than or equal to 1, and a capacity of the target capacitor is equal to a preset threshold. A first end of the resonant capacitor is connected with the second end of the first transformer, and a second end of the resonant capacitor is connected with the first end of the second transformer.

In an embodiment, the H-bridge circuit includes a first switch tube, a second switch tube, a third switch tube and a fourth switch tube. A source electrode of the first switch tube is connected with a drain electrode of the third switch tube, and a formed connecting line is provided with the first output end. A source electrode of the second switch tube is connected with a drain electrode of the fourth switch tube, and a formed connecting line is provided with the second output end. A drain electrode of the first switch tube is connected with a drain electrode of the second switch tube, and a formed connecting line is provided with a positive electrode connection point. A source electrode of the third switch tube is connected with a source electrode of the fourth switch tube, and a formed connecting line is provided with a negative electrode connection point. Respective grid electrodes of the first switch tube, the second switch tube, the third switch tube and the fourth switch tube are respectively connected with a sampling control circuit.

In an embodiment, the load circuit includes a fifth switch tube, a sixth switch tube, a seventh switch tube, an eighth switch tube, a first capacitor and a second capacitor. A source electrode of the fifth switch tube is connected with a source electrode of the sixth switch tube. A source electrode of the seventh switch tube is connected with a source electrode of the eighth switch tube. A drain electrode of the sixth switch tube is connected with a first end of the first capacitor, and a formed connecting line is provided with the first output electrode. A second end of the first capacitor is connected with a first end of the second capacitor. A drain electrode of the eighth switch tube is connected with a second end of the second capacitor, and a formed connecting line is provided with the second output electrode. Respective grid electrodes of the fifth switch tube, the sixth switch tube, the seventh switch tube and the eighth switch tube are respectively connected with the sampling control circuit. A drain electrode of the fifth switch tube is connected with the third end of the first transformer, a drain electrode of the seventh switch tube is connected with the third end of the second transformer, the fourth end of the first transformer is connected with the fourth end of the second transformer, and a formed connection point and the load circuit are connected to a connecting line between the second end of the first capacitor and the first end of the second capacitor. Or, the drain electrode of the fifth switch tube is connected with the fourth end of the first transformer, the drain electrode of the seventh switch tube is connected with the fourth end of the second transformer, the third end of the first transformer is connected with the third end of the second transformer, and a formed connection point and the load circuit are connected to the connecting line between the second end of the first capacitor and the first end of the second capacitor.

In an embodiment, the second output end of the H-bridge circuit is provided with a first current sensor. When the third end of the first transformer is connected with the third end of the second transformer, or, when the fourth end of the first transformer is connected with the fourth end of the second transformer, a connecting line between the formed connection point and the load circuit is provided with a second current sensor. The ground terminal of the H-bridge circuit is provided with a third current sensor. The first current sensor, the second current sensor and the third current sensor are respectively connected with the sampling control circuit. The first current sensor is configured to sample and oscillating current amplitude signals, the second current sensor is configured to sample respective current amplitude signals of the fifth switch tube, the sixth switch tube, the seventh switch tube and the eighth switch tube, and the third current sensor is configured to sample total current amplitude signals when the first switch tube, the second switch tube, the third switch tube and the fourth switch tube work.

In an embodiment, preset point positions sampled by the sampling control circuit include the first current sensor, the second current sensor, the third current sensor, the third end and the fourth end of the first transformer, the third end of the second transformer, the first end of the first capacitor, and the first end and the second end of the second capacitor. According to current or voltage signals of the preset point positions, and power output requirements of the first output electrode and the second output electrode, the sampling control circuit outputs pulse width signals modulated according to waveform functions to control the first switch tube, the second switch tube, the third switch tube and the fourth switch tube to work, and power pulse widths output by a forward transformer control the fifth switch tube, the sixth switch tube, the seventh switch tube and the eighth switch tube to work as synchronous signals.

In an embodiment, the sampling control circuit is configured to: generate pulse signals by changing sinusoidal modulation pulse width, modulation period and phase-shifting time sequence according to respective current amplitude signals of the first switch tube, the second switch tube, the third switch tube, the fourth switch tube, the fifth switch tube, the sixth switch tube, the seventh switch tube and the eighth switch tube, current amplitude signals of the magnet oscillator circuit, sampling voltage amplitude signals of each point in the load circuit, and transmission power requirements for generating appointed waveform functions, and respectively output the pulse signals to the grid electrodes of the first switch tube, the second switch tube, the third switch tube and the fourth switch tube, so that the H-bridge circuit works circularly according to preset working mode; and synchronously control the respective grid electrodes of the fifth switch tube, the sixth switch tube, the seventh switch tube and the eighth switch tube according to pulse power time sequence output to the first transformer and the second transformer, so that the inverter circuit with two serially connected and alternating transformers works circularly, and the first transformer and the second transformer work alternately in the forward and flyback states to ensure that the first switch tube, the second switch tube, the third switch tube, the fourth switch tube, the fifth switch tube, the sixth switch tube, the seventh switch tube and the eighth switch tube are in an on state when respective body diodes are switched on positively.

In an embodiment, the preset working mode includes a first working mode, a second working mode, a third working mode, a fourth working mode, a fifth working mode, a sixth working mode, a seventh working mode and an eighth working mode. The first working mode is that the first switch tube and the fourth switch tube are in the on state, and the second switch tube and the third switch tube are in an off state. In the first working mode, if the fifth switch tube and the sixth switch tube are in the off state, the first transformer is in the flyback state. If the seventh switch tube and the eighth switch tube are in the on state, the second transformer is in the forward state, and power is output to the load circuit through the second transformer. If the fifth switch tube and the sixth switch tube are in the on state, the first transformer is in the forward state, and the power is output to the load circuit through the first transformer. And the seventh switch tube and the eighth switch tube are in the off state, the second transformer is in the flyback state. When the fifth switch tube and the sixth switch tube are in the on state, the first output electrode has a positive voltage. When the seventh switch tube and the eighth switch tube are in the on state, the second output electrode has the positive voltage.

In an embodiment, the second working mode is that the first switch tube is in the off state from the on state, the fourth switch tube keeps the on state, and the second switch tube and the third switch tube keep the off state. In the second working mode, a freewheel characteristic of a primary inductor of a transformer in the flyback state of the first transformer and the second transformer in the first working mode causes the third switch tube to be switched on due to current passing through the body diode of the third switch tube, and the third switch tube is switched on when an voltage drop between the drain electrode and the source electrode of the third switch tube is equal to a positive voltage drop of the body diode of the third switch tube. At this time, the third switch tube is in the on state from the off state, freewheel loss of the body diode of the third switch tube is reduced, and the third working mode is achieved.

In an embodiment, the third working mode is that the third switch tube and the fourth switch tube are in the on state, and the first switch tube and the second switch tube keep the off state. In the third working mode, resonance current of the magnet oscillator circuit passes through the third switch tube and the fourth switch tube to form a closed loop.

In an embodiment, the fourth working mode is that the fourth switch tube is in the off state from the on state, the third switch tube keeps the on state, and the first switch tube and the second switch tube keep the off state. In the fourth working mode, freewheel characteristics of primary inductors of the first transformer and the second transformer cause the body diode of the second switch tube to be switched on for freewheeling, and the second switch tube is switched on when a voltage drop between the drain electrode and the source electrode of the second switch tube is equal to a positive voltage drop of the body diode of the second switch tube. At this time, the second switch tube is in the on state from the off state, freewheel loss of the body diode of the second switch tube is reduced, and the fifth working mode is achieved.

In an embodiment, the fifth working mode is that the second switch tube and the third switch tube are in the on state, and the first switch tube and the fourth switch tube keep the off state. In the fifth working mode, and the fifth switch tube and the sixth switch tube are in the off state, the first transformer is in the flyback state. If the seventh switch tube and the eighth switch tube are in the on state, the second transformer is in the forward state, and power is output to the load circuit through the second transformer. If the fifth switch tube and the sixth switch tube are in the on state, the first transformer is in the forward state, and the power is output to the load circuit through the first transformer. And the seventh switch tube and the eighth switch tube are in the off state, the second transformer is in the flyback state. When the fifth switch tube and the sixth switch tube are in the on state, the first output electrode has a negative voltage. When the seventh switch tube and the eighth switch tube are in the on state, the second output electrode has the negative voltage.

In an embodiment, the sixth working mode is that the third switch tube is in the off state from the on state, the second switch tube keeps the on state, and the first switch tube and the fourth switch tube keep the off state. In the sixth working mode, a freewheel characteristic of a primary inductor of a transformer in the flyback state of the first transformer and the second transformer in a previous working mode causes the body diode of the first switch tube to be switched on for freewheeling, and the first switch tube is switched on when a voltage between the drain electrode and the source electrode of the first switch tube is equal to a positive voltage of the body diode of the first switch tube, freewheel loss of the body diode of the first switch tube is reduced, and the seventh working mode is achieved.

In an embodiment, the seventh working mode is that the first switch tube and the second switch tube are in the on state, and the third switch tube and the fourth switch tube keep the off state. In the seventh working mode, resonance current of the magnet oscillator circuit passes through the first switch tube and the second switch tube to form a closed loop.

In an embodiment, the eighth working mode is that the second switch tube is in the off state from the on state, the first switch tube keeps the on state, and the third switch tube and the fourth switch tube keep the off state. In the eighth working mode, freewheel characteristic of primary inductors of the first transformer and the second transformer cause the body diode of the fourth switch tube to be switched on for freewheeling. The body diode of the fourth switch tube is switched on positively when the drain electrode and the source electrode of the fourth switch tube are in the zero-voltage state, freewheel loss of the body diode of the fourth switch tube is reduced, and the first working mode is achieved.

In an embodiment, the sampling control circuit is also configured to adjust the on time sequence of the fifth switch tube, the sixth switch tube, the seventh switch tube and the eighth switch tube, so that the first transformer and the second transformer work alternately in the forward and flyback states, and are cooperated with the first switch tube, the second switch tube, the third switch tube and the fourth switch tube so that the magnet oscillator circuit is in a complete resonance state during working. When the first transformer is in the forward state, the second transformer is in the flyback state. When the first transformer is in the flyback state, the second transformer is in the forward state. The complete resonance state is achieved by a primary inductor of a transformer in the flyback state in the first transformer or the second transformer and the resonant capacitor, and a transformer in the forward state of the first transformer or the second transformer is configured to transmit power.

In an embodiment, the sampling control circuit is also configured to control on and off of the fifth switch tube, the sixth switch tube, the seventh switch tube and the eighth switch tube so that the first transformer and the second transformer work alternately in the forward and flyback states. When the fifth switch tube and the sixth switch tube are switched on and the seventh switch tube and the eighth switch tube are switched off, the first transformer is in the forward state to provide power, the second transformer is in the flyback state, with a magnetic core being charged participating in resonance. When the fifth switch tube and the sixth switch tube are switched off and the seventh switch tube and the eighth switch tube are switched on, the second transformer is in the forward state to provide power, the first transformer is in the flyback state with a magnetic core being charged and participating in oscillation. When either of the first transformer and the second transformer is in the flyback state, resonance occurs between a primary inductor of a transformer and the resonant capacitor.

In an embodiment, when a primary inductor of a transformer in the flyback state of the first transformer and the second transformer oscillates with the resonant capacitor, the sampling control circuit controls an on pulse width, PWM (Pulse-Width Modulation) period, dead time and phase time sequence of respective grid electrodes of the first switch tube, the second switch tube, the third switch tube and the fourth switch tube, so that the first switch tube, the second switch tube, the third switch tube and the fourth switch tube are in the on state when respective body diodes are switched on, and the magnet oscillator circuit is in a complete resonance state.

In an embodiment, when the fifth switch tube and the sixth switch tube are in the on state, the seventh switch tube and the eighth switch tube are in the off state, the first transformer is in the flyback state, and output power current flows through the fifth switch tube and the sixth switch tube to charge the first capacitor; when the fifth switch tube and the sixth switch tube are in the off state, the seventh switch tube and the eighth switch tube are in the on state, the second transformer is in the forward state, and output power current flows through the seventh switch tube and the eighth switch tube to charge the second capacitor. Switch time sequence of the fifth switch tube, the sixth switch tube, the seventh switch tube and the eighth switch tube is consistent with an output pulse of a forward transformer. When on cycles of the fifth switch tube and the sixth switch tube are consistent with those of the first switch tube and the fourth switch tube, the voltage of the first output electrode is greater than that of the second output electrode, so that the output voltage and current waveform of the load circuit are in a positive half cycle of alternating current. When on cycles of the fifth switch tube and the sixth switch tube are consistent with those of the second switch tube and the third switch tube, the voltage of the second output electrode is greater than that of the first output electrode, so that the output voltage and current waveform of the load circuit are in a negative half cycle of the alternating current.

In an embodiment, when each of the fifth switch tube, the sixth switch tube, the seventh switch tube and the eighth switch tube is switched on, a tube voltage drop of the switch tube is clamped by the body diode of the switch tube, so that the body diode is in a positive on state every time when the switch tube is switched on, and then the switch tube is switched on with a minimum surge current value under a control of the sampling control circuit. The phenomenon of current ringing when a switch tube is switched on is greatly reduced, and loss when the switch tube is switched on is reduced.

In an embodiment, a transformer in the flyback state of the first transformer and the second transformer is stored with oscillation energy, the oscillation energy is transmitted to the load circuit in a next alternating cycle, so that oscillation loss of the first transformer and the second transformer is a minimum, all power devices work in an optimal ultralow loss working condition, and the inverter circuit with two serially connected and alternating transformers is of extremely high transmission efficiency and has a transmitted power of more than 1.5 times of a single transformer in the forward state.

In an embodiment, when the first transformer or the second transformer works in the forward state or the flyback state and a voltage of the first output electrode is greater than that of the second output electrode, a sine wave output by the load circuit is in a positive half cycle, or, when the voltage of the first output electrode is smaller than that of the second output electrode, the sine wave output by the load circuit is in a negative half cycle, which is implemented by the fifth switch tube, the sixth switch tube, the seventh switch tube and the eighth switch tube being cooperated with time sequence of the first switch tube, the second switch tube, the third switch tube and the fourth switch tube. The fifth switch tube and the sixth switch tube, as well as the seventh switch tube and the eighth switch tube are switched on in echelons to achieve a bisynchronous rectification output characteristic, so that output powers of the first output electrode and the second output electrode present fluctuation characteristics of at least one function waveform of a sine function waveform, an exponential function waveform, a square wave function waveform and a trigonometric function waveform according to a characteristic of pulse width modulation.

In an embodiment, when an alternating voltage output when a potential of the first output electrode is higher than that of the second output electrode is in a positive half cycle, the on time sequence of the fifth switch tube and the sixth switch tube is that the fifth switch tube is switched on, and then the sixth switch tube is in the on state from the off state after a body diode of the sixth switch tube is switched on, so that the sixth switch tube is in the state when the body diode between the drain electrode and the source electrode is switched on positively, a counter current does not occur in the first capacitor, and the on fifth switch tube is switched on when working in a zero-voltage and zero-current state. When the alternating voltage output when the potential of the first output electrode is lower than that of the second output electrode is in a negative half cycle, the on time sequence of the fifth switch tube and the sixth switch tube is that the sixth switch tube is switched on, and then the fifth switch tube is in the on state from the off state after a body diode of the fifth switch tube is switched on, so that the fifth switch tube is in the on state when the body diode between the drain electrode and the source electrode is has a positive voltage, a counter current does not occur in the first capacitor, and the on sixth switch tube is switched on when working in the zero-voltage and zero-current state.

In an embodiment, when an alternating voltage output when a potential of the first output electrode is higher than that of the second output electrode is in a positive half cycle, anon time sequence of the fifth switch tube and the sixth switch tube is that the fifth switch tube is switched on, and then the sixth switch tube is in the on state from the off state after a body diode of the sixth switch tube is switched on, so that the sixth switch tube is in the on state when the body diode between the drain electrode and the source electrode has a positive voltage, the counter current does not occur in the first capacitor, and the on fifth switch tube is switched on when working in a zero-voltage and zero-current state. When alternating voltage output when the potential of the first output electrode is lower than that of the second output electrode is in a negative half cycle, the on time sequence of the fifth switch tube and the sixth switch tube is that the sixth switch tube is switched on, and then the fifth switch tube is in the on state from the off state after a body diode of the fifth switch tube is switched on, so that the fifth switch tube is in the on state when the body diode between the drain electrode and the source electrode has positive, the counter current cannot occur in the first capacitor, and the on sixth switch tube is switched on in the zero-voltage and zero-current state.

In an embodiment, each of the first switch tube, the second switch tube, the third switch tube, the fourth switch tube, the fifth switch tube, the sixth switch tube, the seventh switch tube and the eighth switch tube is an MOS (Metal Oxide Semiconductor) switch tube with a body diode. When the MOS switch tube is replaced with an IGBT (Insulated Gate Bipolar Transistor) switch tube with a body diode, a collector electrode of the IGBT switch tube corresponds to the drain electrode of the MOS switch tube, and an emitting electrode of the IGBT switch tube corresponds to the source electrode of the MOS switch tube.

On the other hand, the embodiment of the present disclosure provides an inverter equipment, including any one of the above inverter circuits with two serially connected and alternating transformers.

### BRIEF DESCRIPTION OF THE DRAWINGS

Illustrative embodiments of the present disclosure are described in detail below with reference to the attached drawing figures.

FIG. 1 is a schematic diagram of an inverter circuit with two serially connected and alternating transformers according to an embodiment of the disclosure.

FIG. 2 is a schematic diagram of another inverter circuit with two serially connected and alternating transformers according to an embodiment of the disclosure.

FIG. 3 is a schematic diagram of another inverter circuit with two serially connected and alternating transformers according to an embodiment of the disclosure.

FIG. 4A is a schematic diagram of another inverter circuit with two serially connected and alternating transformers according to an embodiment of the disclosure.

FIG. 4B is a schematic diagram of another inverter circuit with two serially connected and alternating transformers according to an embodiment of the disclosure.

FIG. 5A is a schematic diagram of another inverter circuit with two serially connected and alternating transformers according to an embodiment of the disclosure.

FIG. 5B is a schematic diagram of another inverter circuit with two serially connected and alternating transformers according to an embodiment of the disclosure.

FIG. 6A is a sample diagram of an inverter circuit with two serially connected and alternating transformers according to an embodiment of the disclosure.

FIG. 6B is a sample example of another inverter circuit with two serially connected and alternating transformers according to an embodiment of the disclosure.

### DETAILED DESCRIPTION

The following describes some non-limiting exemplary embodiments of the invention with reference to the accompanying drawings. The described embodiments are merely a part rather than all of the embodiments of the invention. All other embodiments obtained by a person of ordinary skill in the art based on the embodiments of the disclosure shall fall within the scope of the disclosure.

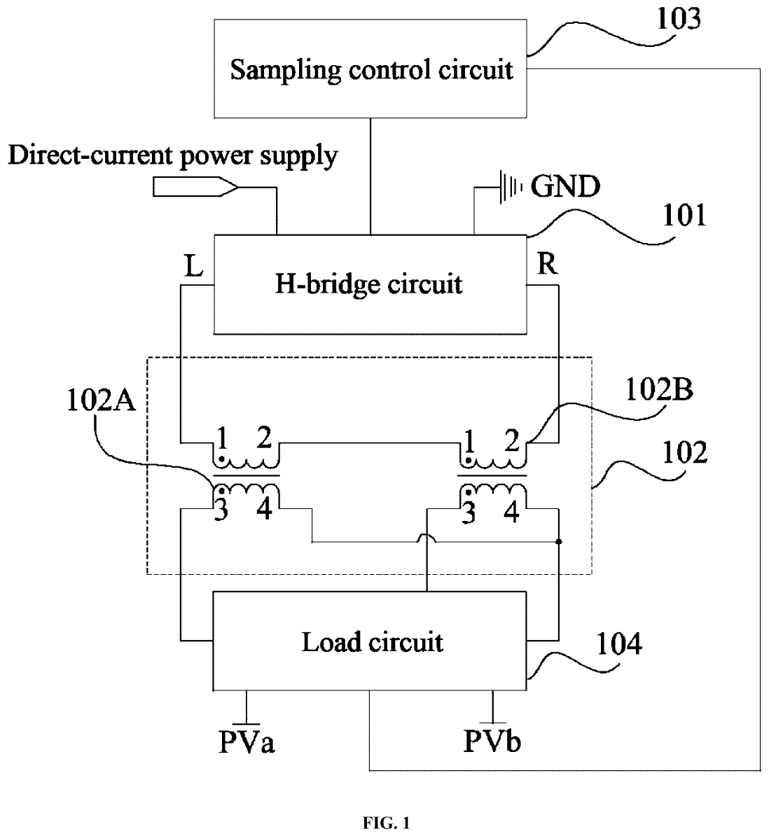

As shown in FIG. 1, an inverter circuit with two serially connected and alternating transformers provided by the embodiment of the present disclosure may include an H-bridge circuit 101, a magnet oscillator circuit 102, a sampling control circuit 103, and a load circuit 104. The magnet oscillator circuit 102 may include a first transformer 102A and a second transformer 102B.

In FIG. 1, a power end of the H-bridge circuit 101 is connected to a positive electrode of a direct-current power supply, and a ground terminal of the H-bridge circuit 101 is connected to a negative electrode of the direct-current power supply. A first output end L of the H-bridge circuit 101 is connected with a first end of the first transformer 102A. A second end of the first transformer 102A is connected with a first end of the second transformer 102B. A second end of the second transformer 102B is connected with a second output end R of the H-bridge circuit 101. A third end of the first transformer 102A is connected with a first end of the load circuit 104. A fourth end of the first transformer 102A is connected with a fourth end of the second transformer 102B. A third end of the second transformer 102B is connected with a second end of the load circuit 104. The fourth end of the second transformer 102B is connected with a third end of the load circuit 104. The sampling control circuit 103 is respectively connected with the H-bridge circuit 101 and the load circuit 104, and is configured to drive the H-bridge circuit 101 and the load circuit 104, so that the first transformer 102A and the second transformer 102B are alternately in forward and flyback states respectively, and after direct current between the positive electrode and the negative electrode of the direct-current power supply is inverted into alternating current, the alternating current is output from a first output electrode PVa and a second output electrode PVb of the load circuit 104.

The first transformer 102A and the second transformer 102B are alternately in forward and flyback states respectively. That is, when the first transformer 102A is in the forward state, the second transformer 102B is in the flyback state; when the first transformer 102A is in the flyback state, the second transformer 102B is in the forward state; moreover, the first transformer is in the forward and flyback states repeatedly and alternately, and correspondingly, the second transformer 102B is in the flyback and forward states repeatedly and alternately. Based on this, a power output between the first output electrode and the second output electrode of the load circuit 104 is the sum powers of the two transformers, so that the power transmission efficiency may be improved.

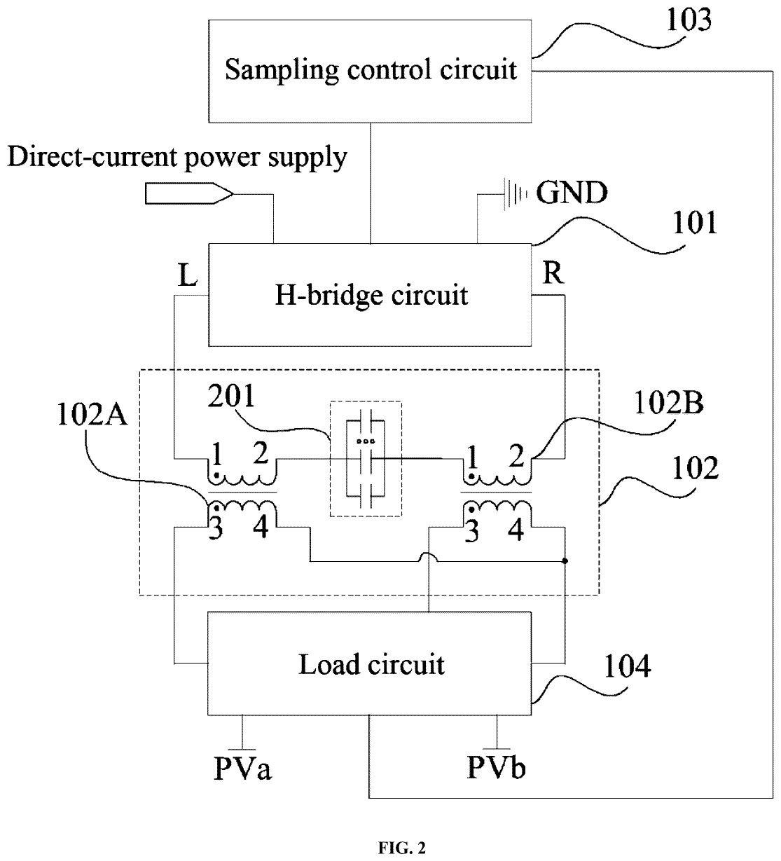

In an embodiment, as shown in FIG. 2, the magnet oscillator circuit 102 also may include a resonant capacitor 201 serially connected with the first transformer 102A and the second transformer 102A. The resonant capacitor 201 consists of x target capacitors connected in parallel, x is an integral number of greater than or equal to 1, and a capacity of each target capacitor is equal to a preset threshold. A first end of the resonant capacitor 201 is connected with the second end of the first transformer 102A, and a second end of the resonant capacitor is connected with the first end of the second transformer. In this circuit, the first transformer and the second transformer are arranged on both sides of the resonant capacitor, and are designed in symmetrical balance. The resonant capacitor consists of X small-capacity capacitors connected in parallel, so that an internal resistance of the capacitor is effectively reduced, a current passing through the magnet oscillator circuit is increased, a loss and a temperature rise caused by the capacitor are reduced, a current carrying capacity of a series circuit may be improved, and then a transmission efficiency of the magnet oscillator circuit may be improved. In the circuit diagram as shown in FIG. 1, the resonant capacitor may also be canceled to meet the requirements of high-power applications.

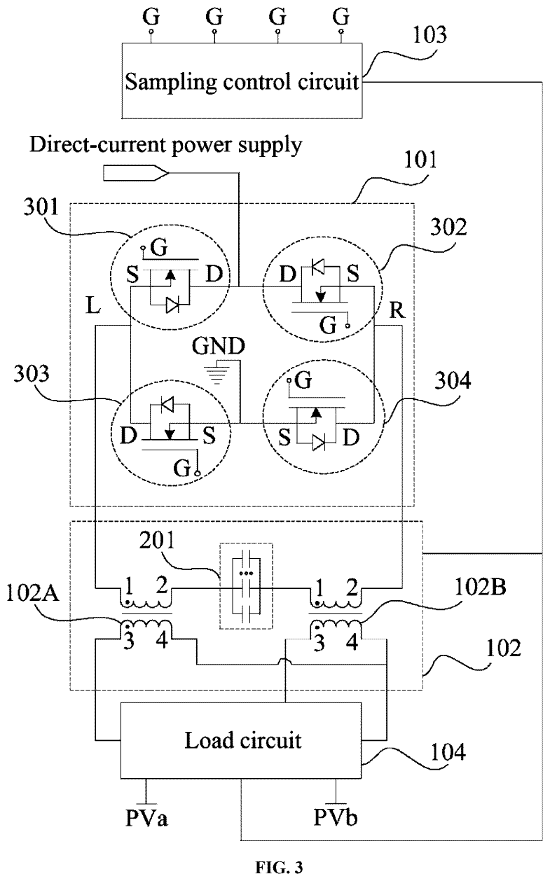

Optionally, as shown in FIG. 3, the H-bridge circuit 101 may include a first switch tube 301, a second switch tube 302, a third switch tube 303 and a fourth switch tube 304. A pin S of a source electrode of the first switch tube 301 is connected with a pin D of a drain electrode of the third switch tube 303, and a formed connecting line is provided with the first output end L. A pin S of a source electrode of the second switch tube 302 is connected with a pin D of a drain electrode of the fourth switch tube 304, and a formed connecting line is provided with the second output end R. A pin D of a drain electrode of the first switch tube 301 is connected with a pin D of a drain electrode of the second switch tube 302, and a formed connecting line is provided with a positive electrode connection point. The positive electrode connection point is connected with the positive electrode of the direct-current power supply. A pin S of a source electrode of the third switch tube 303 is connected with a pin S of a source electrode of the fourth switch tube 304, and a formed connecting line is provided with a negative electrode connection point. The negative electrode connection point is connected with the negative electrode of the direct-current power supply. Pins G of grid electrodes of the first switch tube 301, the second switch tube 302, the third switch tube 303 and the fourth switch tube 304 are respectively connected with a sampling controller 103 (specific connecting lines are not shown in FIG. 3).

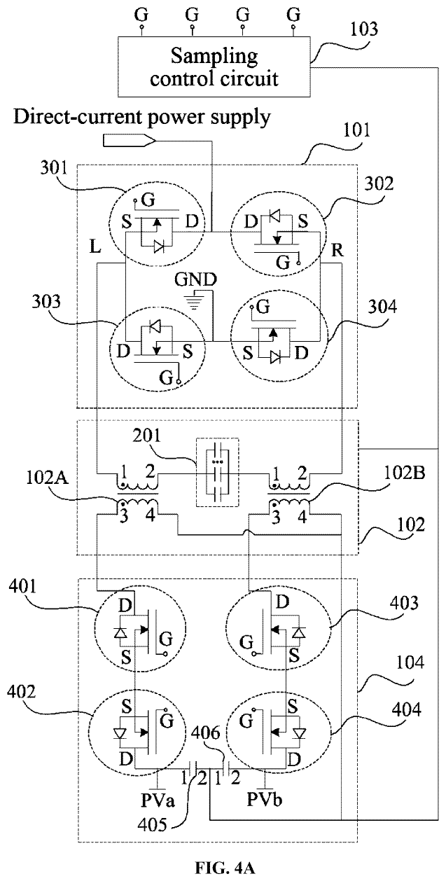

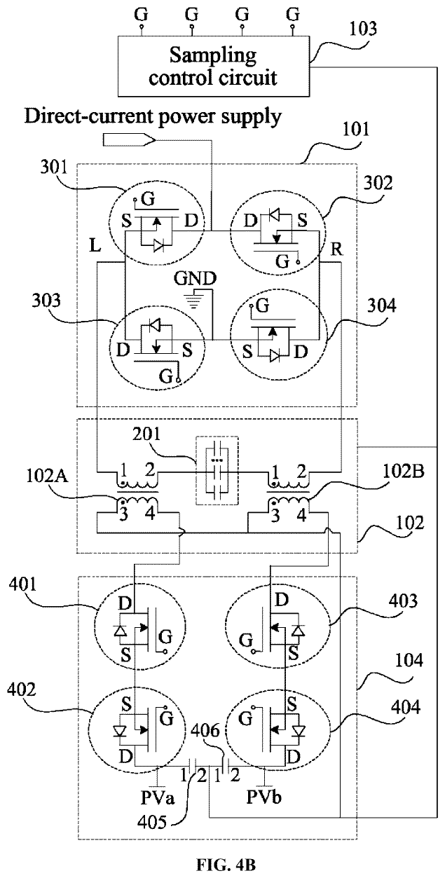

Optionally, as shown in FIG. 4A and FIG. 4B, the load circuit 104 may include a fifth switch tube 401, a sixth switch tube 402, a seventh switch tube 403, an eighth switch tube 404, a first capacitor 405 and a second capacitor 406. A pin S of a source electrode of the fifth switch tube 401 is connected with a pin S of a source electrode of the sixth switch tube 402. A pin S of a source electrode of the seventh switch tube 403 is connected with a pin S of a source electrode of the eighth switch tube 404. A pin D of a drain electrode of the sixth switch tube 402 is connected with a first end of the first capacitor 405, and a formed connecting line is provided with the first output electrode PVa. A second end of the first capacitor 405 is connected with a first end of the second capacitor 406. A pin D of a drain electrode of the eighth switch tube 404 is connected with a second end of the second capacitor 406, and a formed connecting line is provided with the second output electrode PVb. Pins G of grid electrodes of the fifth switch tube 401, the sixth switch tube 402, the seventh switch tube 403 and the eighth switch tube 404 are respectively connected with the sampling control circuit 103 (specific connecting lines are not shown in FIG. 4A and FIG. 4B).

Referring to FIG. 4A, a pin D of a drain electrode of the fifth switch tube 401 is connected with the third end of the first transformer 102A, a pin D of a drain electrode of the seventh switch tube 403 is connected with the third end of the second transformer 102B, the fourth end of the first transformer 102A is connected with the fourth end of the second transformer 102B, and a formed connection point and the load circuit 104 are connected to a connecting line between the second end of the first capacitor 405 and the first end of the second capacitor 406. Or, referring to FIG. 4B, the pin D of a drain electrode of the fifth switch tube 401 is connected with the fourth end of the first transformer 102A, the pin D of a drain electrode of the seventh switch tube 403 is connected with the fourth end of the second transformer 102B, the third end of the first transformer 102A is connected with the third end of the second transformer 102B, and a formed connection point and the load circuit 104 are connected to the connecting line between the second end of the first capacitor 405 and the first end of the second capacitor 406.

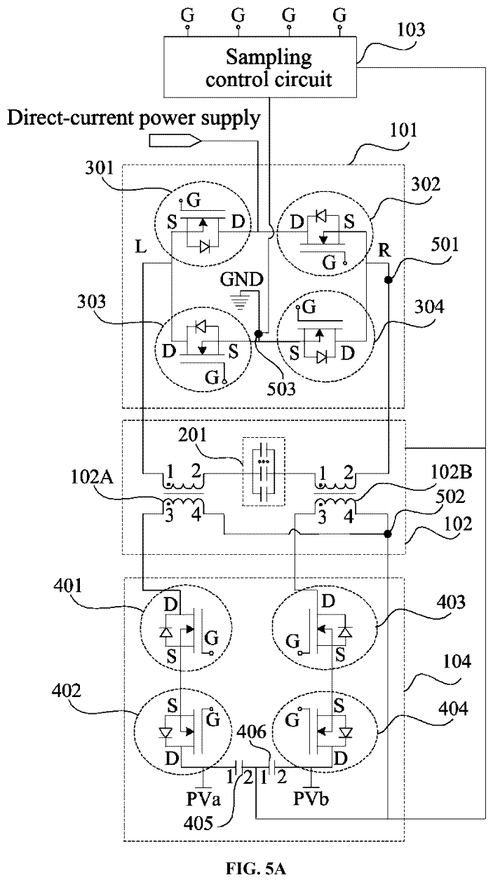

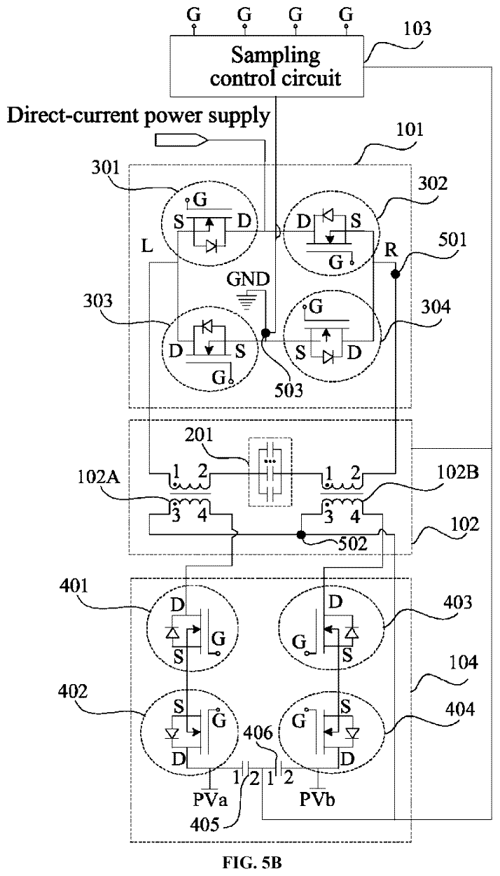

Optionally, as shown in FIG. 5A and FIG. 5B, the second output end R of the H-bridge circuit 101 is provided with a first current sensor 501. When the third end of the first transformer 102A is connected with the third end of the second transformer 102B, or, when the fourth end of the first transformer 102A is connected with the fourth end of the second transformer 102B, a connecting line between the formed connection point and the load circuit 104 is provided with a second current sensor 502. The ground terminal of the H-bridge circuit 101 is provided with a third current sensor 503. The first current sensor 501, the second current sensor 502 and the third current sensor 503 are respectively connected with the sampling control circuit 103. The first current sensor 501 is configured to sample oscillating current amplitude signals in the magnet oscillator circuit, the second current sensor 502 is configured to sample current amplitude signals of the fifth switch tube 401, the sixth switch tube 402, the seventh switch tube 403 and the eighth switch tube 404, and the third sensor 503 is configured to sample total current amplitude signals when the first switch tube 301, the second switch tube 302, the third switch tube 303 and the fourth switch tube 304 working.

Optionally, preset point positions sampled by the sampling control circuit 103 include the first current sensor 501, the second current sensor 502, the third current sensor 503, the third end and the fourth end of the first transformer 102A, the third end of the second transformer 102B, the first end of the first capacitor 405, and the first end and the second end of the second capacitor 406. According to current or voltage signals of the preset point positions, and power output requirements of the first output electrode PVa and the second output electrode PVb, the sampling control circuit 103 outputs pulse width signals modulated according to waveform functions to control the first switch tube 301, the second switch tube 302, the third switch tube 303 and the fourth switch tube 304 to work, and power pulse widths output by a transformer in the forward state control the fifth switch tube 401, the sixth switch tube 402, the seventh switch tube 403 and the eighth switch tube 404 to work as synchronous signals. It is easy to understand that the preset point positions sampled by the sampling control circuit 103 are all connected to the sampling controller (specific connecting lines are not shown in FIG. 5A and FIG. 5B.).

In the above circuit, the sampling control circuit 103 is configured to: generate pulse signals by changing sinusoidal modulated pulse width, modulation period and phase-shifting time sequence according to current amplitude signals of the first switch tube 301, the second switch tube 302, the third switch tube 303, the fourth switch tube 304, the fifth switch tube 401, the sixth switch tube 402, the seventh switch tube 403 and the eighth switch tube 404, current amplitude signals of the magnet oscillator circuit 102, sampling voltage amplitude signals of points in the load circuit 104, and transmission power requirements for generating appointed waveform functions, and respectively outputting the pulse signals to the respective pins G of grid electrodes of the first switch tube 301, the second switch tube 302, the third switch tube 303 and the fourth switch tube 304, so that the H-bridge circuit 101 works circularly according to preset working mode; and synchronously controlling the respective pins G of grid electrodes of the fifth switch tube 401, the sixth switch tube 402, the seventh switch tube 403 and the eighth switch tube 404 according to pulse power time sequence output to the first transformer 102A and the second transformer 102B, so that the inverter circuit with two serially connected and alternating transformers works circularly, and the first transformer 102A and the second transformer 102B work alternately in forward and flyback states to ensure that the first switch tube 301, the second switch tube 302, the third switch tube 303, the fourth switch tube 304, the fifth switch tube 401, the sixth switch tube 402, the seventh switch tube 403 and the eighth switch tube 404 are in an on state when respective body diodes are switched on positively.

During the process, the preset working mode include a first working mode, a second working mode, a third working mode, a fourth working mode, a fifth working mode, a sixth working mode, a seventh working mode and an eighth working mode.

Optionally, the first working mode is that the first switch tube 301 and the fourth switch tube 304 are in the on state, and the second switch tube 302 and the third switch tube 303 are in the off state.

In the embodiment of the application, the fifth switch tube 401 and the sixth switch tube 402 form one switch group, and the seventh switch tube 403 and the eighth switch tube 404 form another switch group, so the two switch groups cannot be switched on or off at the same time. Specifically, when the fifth switch tube 401 and the sixth switch tube 402 are in the on state, the seventh switch tube 403 and the eighth switch tube 404 are in the off state. When the fifth switch tube 401 and the sixth switch tube 402 are in the off state, the seventh switch tube 403 and the eighth switch tube 404 are in the on state.

Based on this, in the first working mode, the direct-current power supply charges the magnet oscillator circuit 102 through the first switch tube 301 and the fourth switch tube 304. A current flows in a direction from the first end of the first transformer 102A, the second end of the first transformer 102A, the first end of the resonant capacitor 201, the second end of the resonant capacitor 201, the first end of the second transformer 102B to the second end of the second transformer 102B in sequence. At this time, if the fifth switch tube 401 and the sixth switch tube 402 are in the off state, the first transformer 102A is in the flyback state. The fifth switch tube 401 and the sixth switch tube 402, as well as the seventh switch tube 403 and the eighth switch tube 404 cannot be switched on or switched off at the same time, so the seventh switch tube 403 and the eighth switch tube 404 are in the on state, and the second transformer 102B is in the forward state, a power is output to the load circuit 104 through the second transformer 102B. Similarly, if the fifth switch tube 401 and the sixth switch tube 402 are in the on state, the first transformer 102A is in the forward state, and the power is output to the load circuit through the first transformer. At this time, the fifth switch tube 401 and the sixth switch tube 402, as well as the seventh switch tube 403 and the eighth switch tube 404 cannot be switched on or switched off at the same time, so the seventh switch tube 403 and the eighth switch tube 404 are in the off state, and the second transformer 102B is in the flyback state. When the fifth switch tube 401 and the sixth switch tube 402 are in the on state, the first output electrode PVa has a positive voltage; and when the seventh switch tube 403 and the eighth switch tube 404 are in the on state, the second output electrode PVb has the positive voltage.

Optionally, the second working mode is that the first switch tube 301 is in the off state from the on state, the fourth switch tube 304 keeps the on state, and the second switch tube 302 and the third switch tube 303 keep the off state. In the second working mode, freewheel characteristic of a primary inductor of a transformer in the flyback state of the first transformer 102A and the second transformer 102B in the first working mode cause the body diode of the third switch tube 303 to be switched on due to current passing through, the body diode is switched on when a voltage drop between the pin D of the drain electrode and the pin S of the source electrode of the third switch tube 303 is equal to a positive voltage drop of the body diode of the third switch tube 303. At this time, the third switch tube 303 is in the on state from the off state, a freewheel loss of the body diode of the third switch tube 303 is reduced, and the third working mode is achieved.

Optionally, the third working mode is that the third switch tube 303 and the fourth switch tube 304 are in the on state, and the first switch tube 301 and the second switch tube 302 keep the off state. In the third working mode, resonance current of the magnet oscillator circuit 102 passes through the third switch tube 303 and the fourth switch tube 304 to form a closed loop.

Optionally, the fourth working mode is that the fourth switch tube 304 is in the off state from the on state, the third switch tube 303 keeps the on state, and the first switch tube 301 and the second switch tube 302 keep the off state. In the fourth working mode, freewheel characteristics of primary inductors of the first transformer 102A and the second transformer 102B cause the body diode of the second switch tube 302 to be switched on for freewheeling, the body diode is switched on when a voltage drop between the pin D of the drain electrode and the pin S of the source electrode of the second switch tube 302 is equal to a positive voltage drop of the body diode of the second switch tube 302. At this time, the second switch tube 302 is in the on state from the off state, a freewheel loss of the body diode of the second switch tube 302 is reduced, and the fifth working mode is achieved.

Optionally, the fifth working mode is that the second switch tube 302 and the third switch tube 303 are in the on state, and the first switch tube 301 and the fourth switch tube 304 keep the off state. In the fifth working mode, the direct-current power supply charges the magnet oscillator circuit 102 through the second switch tube 302 and the switch tube 303. A current flows in a direction from the second end of the second transformer 102B, the first end of the second transformer 102B, the second end of the resonant capacitor 201, the first end of the resonant capacitor 201, the second end of the first transformer 102A to the first end of the second transformer 102A in sequence. At this time, if the fifth switch tube 401 and the sixth switch tube 402 are in the off state, the first transformer 102A is in the flyback state. The fifth switch tube 401 and the sixth switch tube 402, as well as the seventh switch tube 403 and the eighth switch tube 404 cannot be switched on or switched off at the same time, so the seventh switch tube 403 and the eighth switch tube 404 are in the on state, the second transformer 102B is in the forward state, and the power is output to the load circuit 104 through the second transformer 102B. Similarly, if the fifth switch tube 401 and the sixth switch tube 402 are in the on state, the first transformer 102A is in the forward state, and the power is output to the load circuit through the first transformer 102A. Moreover, the fifth switch tube 401 and the sixth switch tube 402, as well as the seventh switch tube 403 and the eighth switch tube 404 cannot be switched on or switched off at the same time, so the seventh switch tube 403 and the eighth switch tube 404 are in the off state, and the second transformer 102B is in the flyback state. When the fifth switch tube 401 and the sixth switch tube 402 are in the on state, the first output electrode PVa has a negative voltage; and when the seventh switch tube 403 and the eighth switch tube 404 are in the on state, the second output electrode PVb has the negative voltage.

Optionally, the sixth working mode is that the third switch tube 303 is in the off state from the on state, the second switch tube 302 keeps the on state, and the first switch tube 301 and the fourth switch tube 304 keep the off state. In the sixth working mode, freewheel characteristic of a primary inductor of a transformer in the flyback state of the first transformer 102A and the second transformer 102B in a previous working mode cause the body diode of the first switch tube 301 to be switched on due to current passing through, the body diode is switched on when a voltage between the pin D of the drain electrode and the pin S of the source electrode of the first switch tube 301 is equal to a positive voltage of the body diode of the first switch tube 301, so that a freewheel loss of the body diode of the first switch tube 301 is reduced, and the seventh working mode is achieved.

Optionally, the seventh working mode is that the first switch tube 301 and the second switch tube 302 are in the on state, and the third switch tube 303 and the fourth switch tube 304 keep the off state. In the seventh working mode, resonance current of the magnet oscillator circuit 102 passes through the first switch tube 301 and 302 the second switch tube to form a closed loop.

Optionally, the eighth working mode is that the second switch tube 302 is in the off state from the on state, the first switch tube 301 keeps the on state, and the third switch tube 303 and the fourth switch tube 304 keep the off state. In the eighth working mode, freewheel characteristics of primary inductors of the first transformer 102A and the second transformer 102B cause the body diode of 304 the fourth switch tube to be switched on for freewheeling. When the pin D of the drain electrode and the pin S of the source electrode of the fourth switch tube 304 are in a zero-voltage state, the body diode of the fourth switch tube 304 is switched on positively, so that a freewheel loss of the body diode of the fourth switch tube 304 is reduced, and the first working mode is achieved.

The first working mode, the second working mode, the third working mode, the fourth working mode, the fifth working mode, the sixth working mode, the seventh working mode and the eighth working mode are carried out cyclically. Each cycle is a power transmission period, so that direct current is inverted into alternating current, and high-efficiency transmission of power is achieved. In this process, each switch tube is switched on when a voltage Vds between the drain electrode and the source electrode is zero, so that a switching loss is effectively reduced.

In this process, any one of the first switch tube 301, the second switch tube 302, the third switch tube 303, the fourth switch tube 304, the fifth switch tube 401, the sixth switch tube 402, the seventh switch tube 403 and the eighth switch tube 404 works in a zero-crossing on state, so that a lowest loss on working condition is ensured, a current ringing at the moment of switching on is at a lowest amplitude, and the radiated interference is greatly reduced. At the same time, the switch tube which enters an oscillation circuit and is about to be switched on is controlled to enter the zero-crossing on-off state by adjusting the dead time.

In the above circuit, the sampling control circuit 103 is also configured to adjust the on time sequence of the fifth switch tube 401, the sixth switch tube 402, the seventh switch tube 403 and the eighth switch tube 404 so that the first transformer 102A and the second transformer 102B work alternately in forward and flyback states. Specifically, when the first transformer 102A is in the forward state, the second transformer 102B is in the flyback state. When the first transformer 102A is in the flyback state, the second transformer 102B is in the forward state. The first transformer 102A and the second transformer 102B are alternately staggered in the flyback and forward states. In the process, cooperating with the first switch tube 301, the second switch tube 302, the third switch tube 303 and the fourth switch tube 304, the magnet oscillator circuit 102 is in the complete resonance state during working. When the first transformer 102A is in the forward state, the second transformer 102B is in the flyback state. When the first transformer 102A is in the flyback state, the second transformer 102B is in the forward state. The complete resonance state is achieved by the primary inductor of the transformer in the flyback state in the first transformer 102A or the second transformer 102B and the resonant capacitor, and a transformer in the forward state of the first transformer 102A or the second transformer 102B is configured to transmit power.

Optionally, the sampling control circuit 103 is also configured to control the on and off of the fifth switch tube 401, the sixth switch tube 402, the seventh switch tube 403 and the eighth switch tube 404 so that the first transformer 102A and the second transformer 102B work alternately in forward and flyback states. When the fifth switch tube 401 and the sixth switch tube 402 are switched on and the seventh switch tube 403 and the eighth switch tube 404 are switched off, the first transformer 102A is in the forward state to provide power, the second transformer 102B is in the flyback state, and a magnetic core thereof is charged and participates in resonance. When the fifth switch tube 401 and the sixth switch tube 402 are switched off and the seventh switch tube 403 and the eighth switch tube 404 are switched on, the second transformer 102B is in the forward state to provide power, the first transformer 102A is in the flyback state, and a magnetic core thereof is charged and participates in oscillation. When either of the first transformer 102A and the second transformer 102B is in the flyback state, resonance occurs between the primary inductor of the transformer and the resonant capacitor.

In an embodiment, when the primary inductor of the transformer in the flyback state of the first transformer 102A and the second transformer 102B oscillates with the resonant capacitor, the sampling control circuit 103 controls a on pulse width, PWM period, dead time and phase time sequence of pin G of respective grid electrode of the first switch tube 301, the second switch tube 302, the third switch tube 303 and the fourth switch tube 304, so that the first switch tube 301, the second switch tube 302, the third switch tube 303 and the fourth switch tube 304 are in the on state when the respective body diode is switched on, and the magnet oscillator circuit is in the complete resonance state.

In an embodiment, when the fifth switch tube 401 and the sixth switch tube 402 are in the on state, the seventh switch tube 403 and the eighth switch tube 404 are in the off state, the first transformer 102A is in the flyback state, and output power current flows through the fifth switch tube 401 and the sixth switch tube 402 to charge the first capacitor 405. When the fifth switch tube 401 and the sixth switch tube 402 are in the off state, the seventh switch tube 403 and the eighth switch tube 404 are in the on state, the second transformer 102B is in the forward state, and output power current flows through the seventh switch tube 403 and the eighth switch tube 404 to charge the second capacitor 406.

Under normal working conditions, switch time sequence of the fifth switch tube 401, the sixth switch tube 402, the seventh switch tube 403 and the eighth switch tube is consistent with an output pulse of the forward transformer. When on cycles of the fifth switch tube 401 and the sixth switch tube 402 are consistent with those of the first switch tube 301 and the fourth switch tube 304, a voltage of the first output electrode PVa is greater than that of the second output electrode PVb, so that output voltage and current waveforms of the load circuit 104 are in a positive half cycle of alternating current. When the on cycles of the fifth switch tube 401 and the sixth switch tube 402 are consistent with those of the second switch tube 402 and the third switch tube 403, the voltage of the second output electrode PVb is greater than that of the first output electrode PVa, so that the output voltage and current waveforms of the load circuit 104 are in a negative half cycle of alternating current.

In an embodiment, when each of the fifth switch tube 401, the sixth switch tube 402, the seventh switch tube 403 and the eighth switch tube 404 is switched on, a tube voltage drop of an on switch tube is clamped by the body diode of the switch tube, so that the body diode is in the positive on state every time when the switch tube is switched on, and then the switch tube is switched on with a minimum surge current value under a control of the sampling control circuit. The phenomenon of current ringing when the switch tube is switched on is greatly reduced, and the loss when the switch tube is switched on is reduced.

In an embodiment, the transformer in the flyback state of the first transformer 102A and the second transformer 102B is stored with oscillation energy, the oscillation energy is transmitted to the load circuit 104 in a next alternating cycle. Namely, when the flyback state is switched into the forward state, the oscillation energy is transferred to the load circuit 104, oscillation losses of the first transformer 102A and the second transformer 102B are the minimum, all power devices work in the optimal ultralow loss working conditions, and the inverter circuit with two serially connected and alternating transformers may be of extremely high transmission efficiency and transmitted power of more than 1.5 times of a single transformer in the forward state.

In an embodiment, when the first transformer 102A or the second transformer 102B works in the forward state or the flyback state and the voltage of the first output electrode PVa is greater than that of the second output electrode PVb, sine waves output by the load circuit 104 are in the positive half cycle, or, when the voltage of the first output electrode is smaller than that of the second output electrode, sine waves output by the load circuit are in the negative half cycle, and the fifth switch tube 401, the sixth switch tube 402, the seventh switch tube 403 and the eighth switch tube 404 are cooperated with the time sequence of the first switch tube 301, the second switch tube 302, the third switch tube 303 and the fourth switch tube 304 to complete the sine waves. The fifth switch tube 401 and the sixth switch tube 402, as well as the seventh switch tube 403 and the eighth switch tube 404 are switched on in echelons to achieve bisynchronous rectification output characteristic, so that the output power of the first output electrode PVa and the second output electrode PVb presents a fluctuation characteristic of at least one function waveform of sine function waveform, exponential function waveform, square wave function waveform and trigonometric function waveform according to a characteristic of pulse width modulation.

In an embodiment, when an alternating voltage output when a potential of the first output electrode PVa is higher than that of the second output electrode PVa is in a positive half cycle, the on time sequence of the fifth switch tube 401 and the sixth switch tube 402 is that the fifth switch tube 401 is switched on, and then the sixth switch tube 402 is in the on state from the off state after the body diode of the sixth switch tube 402 is switched on, so that the sixth switch tube is in the on state when the body diode between the drain electrode and the source electrode is switched on positively, a counter current cannot occur in the first capacitor 405, and the on fifth switch tube 401 is switched on when working in a zero-voltage and zero-current state. When the alternating voltage output when the potential of the first output electrode PVa is lower than that of the second output electrode PVb is in a negative half cycle, the on time sequence of the fifth switch tube 401 and the sixth switch tube 402 is that the sixth switch tube 402 is switched on, and then the fifth switch tube 401 is in the on state from the off state after the body diode of the fifth switch tube is switched on, so that the fifth switch tube 401 is in the on state when the body diode between the drain electrode and the source electrode has a positive voltage, the counter current cannot occur in the first capacitor 405, and the on sixth switch tube 402 is switched on when working in the zero-voltage and zero-current state.

In an embodiment, when the seventh switch tube 403 and the eighth switch tube 404 are switched on, and when alternating voltage output when the potential of the first output electrode PVa is higher than that of the second output electrode PVb is in a positive half cycle, the on time sequence of the seventh switch tube 403 and the eighth switch tube 404 is that the eighth switch tube 404 is switched on first, and then the seventh switch tube 403 is in the on state from the off state after the body diode of the seventh switch tube 403 is switched on, so that the seventh switch tube 403 is in the on state when the body diode between the drain electrode and the source electrode is switched on positively, counter current cannot occur in the second capacitor 406, and the on eighth switch tube 404 is switched on when working in the zero-voltage and zero-current state. When alternating voltage output when the potential of the first output electrode PVa is lower than that of the second output electrode PVb is in a negative half cycle, the on time sequence of the seventh switch tube 403 and the eighth switch tube 404 is that the seventh switch tube 403 is switched on, and then the eighth switch tube 404 is in the on state from the off state after the body diode of the eighth switch tube 404 is switched on, so that the eighth switch tube 404 is in the on state when the body diode between the drain electrode and the source electrode is switched on positively, counter current cannot occur in the second capacitor 406, and the on seventh switch tube 403 is switched on when working in the zero-voltage and zero-current state.

In an embodiment, each of the first switch tube 301, the second switch tube 302, the third switch tube 303, the fourth switch tube 304, the fifth switch tube 401, the sixth switch tube 402, the seventh switch tube 403 and the eighth switch tube 404 is MOS switch tube with a body diode. When the MOS switch tube is replaced with an IGBT switch tube with a body diode, a collector electrode C of the IGBT switch tube corresponds to a drain electrode D of the MOS switch tube, and an emitting electrode E of the IGBT switch tube corresponds to a source electrode S of the MOS switch tube.

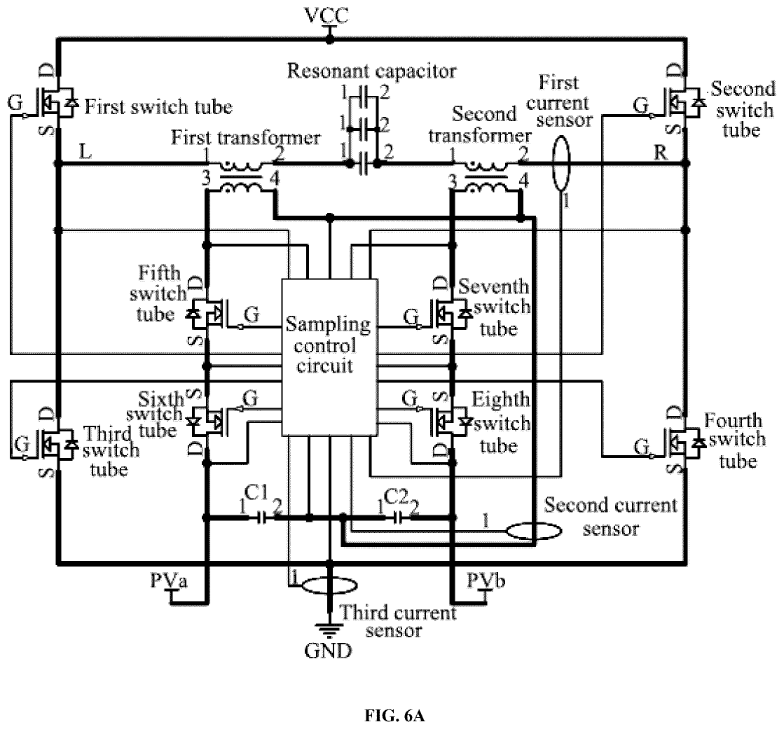

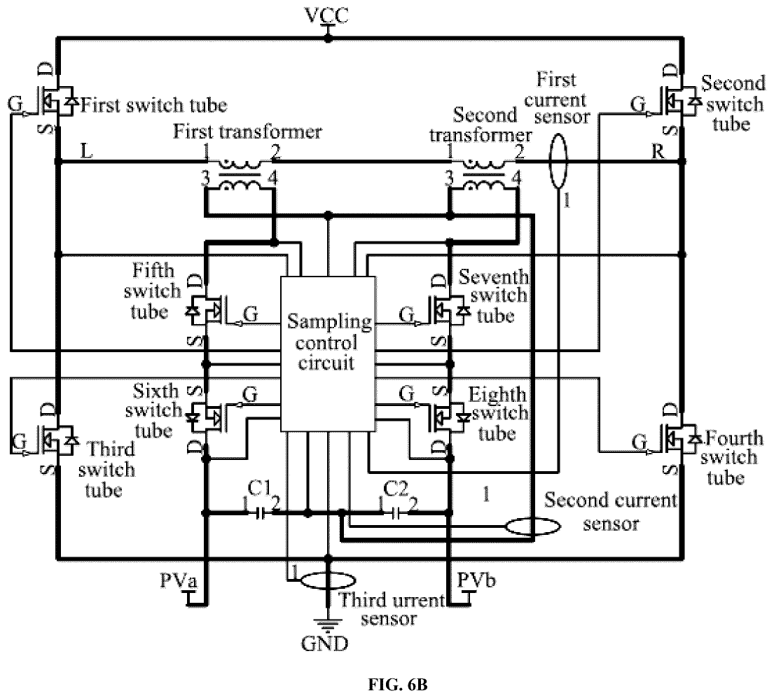

In order to explain the technical solution of the present disclosure in more detail, as shown in FIG. 6A or FIG. 6B, example diagrams of an inverter circuit with two serially connected and alternating transformers provided by the embodiments of the present disclosure are suitable for DC/AC (Direct-Current/Alternating-Current) power inverters and inverter electronic equipment, and are applied to the technical field of power electronics. Each circuit may include the H-bridge circuit, the magnet oscillator circuit, the sampling control circuit and the load circuit. The H-bridge circuit may include the first switch tube, the second switch tube, the third switch tube and the fourth switch tube. The magnet oscillator circuit may include the first transformer, the second transformer and the resonant capacitor, and the resonant capacitor consists of a plurality of small capacitors in parallel. The load circuit may include the fifth switch tube, the sixth switch tube, the seventh switch tube and the eighth switch tube, the capacitor C1 and the capacitor C2. The sampling control circuit collects the current and voltage signals of the double transformer series alternating inverter circuit through the first current sensor, the second current sensor and the third current sensor.

In each circuit, the power end VCC and the ground GND of the H-bridge circuit are connected to the direct-current power supply, and the first transformer and the second transformer are arranged on both sides of the resonant capacitor, and are designed in symmetrical balance. The sampling control circuit ensures that each switch tube works in a range of safe current and voltage by collecting currents and voltages of the first current sensor, the second current sensor, the third current sensor, the third end and the fourth end of the first transformer, the third end of the second transformer, the first end of the capacitor C1, the first end and the second end of the capacitor C2. Specifically, the first working mode, the second working mode, the third working mode, the fourth working mode, the fifth working mode, the sixth working mode, the seventh working mode and the eighth working mode are carried out cyclically, so that the first transformer and the second transformer are alternately in forward and flyback states, and then alternating current is output between the electrode PVa and the electrode PVb. Each cycle is a power transmission period, so that direct current is inverted into alternating current, and high-efficiency transmission of power is achieved. In this process, each switch tube is switched on in the zero state when the voltage Vds between the drain electrode and the source electrode is zero, so that the switching loss is effectively reduced.

In each circuit, the resonant capacitor consists of X small-capacity capacitors connected in parallel, so that the internal resistance of the capacitor is effectively reduced, the current carrying capacity of a series circuit may be improved, and then the transmission efficiency of the magnet oscillator circuit may be improved. In addition, the resonant capacitor may also be canceled to meet the requirements of high-power applications. In addition, the first transformer and the second transformer are alternately in forward and flyback states respectively, so power output between the electrode PVa and the electrode PVb is the sum of the power of the two transformers without inductance energy loss, and then the power transfer efficiency and transmission power may be improved.

The present disclosure also provides an inverter equipment, including any one of above circuits with two serially connected and alternating transformers, to achieve functions thereof. The principles and technical effects may refer to any of the above circuits with two serially connected and alternating transformers, and unnecessary details are not given here.

Various embodiments of the disclosure may have one or more of the following effects. In some embodiments, the disclosure provides an inverter circuit with two serially connected and alternating transformers and inverter equipment. The circuit may include an H-bridge circuit, a magnet oscillator circuit, a sampling control circuit and a load circuit. The magnet oscillator circuit may include a first transformer and a second transformer. The H-bridge circuit and the load circuit are driven by the sampling controller, so that the first transformer and the second transformer are alternately in forward and flyback states respectively, and then alternating current is output between the first output electrode and the second output electrode of the load circuit to achieve inversion for the direct-current power supply. In addition, the first transformer and the second transformer are alternately in the forward and flyback states respectively, so power output between the first output electrode and the second output electrode is the sum of the power of the two transformers without inductance energy loss, and then the power transfer efficiency and transmission power may be improved.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

The disclosure claimed is:

1. An inverter circuit with two serially connected and alternating transformers, comprising an H-bridge circuit, a magnet oscillator circuit, a sampling control circuit and a load circuit, wherein:
the magnet oscillator circuit comprises a first transformer and a second transformer;
a power end of the H-bridge circuit is connected to a positive electrode of a direct-current power supply, and a ground terminal of the H-bridge circuit is connected to a negative electrode of the direct-current power supply;
a first output end of the H-bridge circuit is connected with a first end of the first transformer, a second end of the first transformer is connected with a first end of the second transformer, and a second end of the second transformer is connected with a second output end of the H-bridge circuit;
a third end of the first transformer is connected with a first end of the load circuit, a fourth end of the first transformer is connected with a fourth end of the second transformer, a third end of the second transformer is connected with a second end of the load circuit, and the fourth end of the second transformer is connected with a third end of the load circuit; and
the sampling control circuit is respectively connected with the H-bridge circuit and the load circuit and the sampling control circuit is configured to drive the H-bridge circuit and the load circuit, so that the first transformer and the second transformer are alternately in a forward state and a flyback state, and alternating current is output between a first output electrode and a second output electrode of the load circuit.

2. The inverter circuit according to claim 1, wherein:
the magnet oscillator circuit comprises a resonant capacitor serially connected with the first transformer and the second transformer, the resonant capacitor consists of x target capacitors connected in parallel, x is an integral number of greater than or equal to 1, and a capacity of the target capacitor is equal to a preset threshold; and
a first end of the resonant capacitor is connected with the second end of the first transformer, and a second end of the resonant capacitor is connected with the first end of the second transformer.

3. The inverter circuit according to claim 1, wherein:
the H-bridge circuit comprises a first switch tube, a second switch tube, a third switch tube and a fourth switch tube;
a source electrode of the first switch tube is connected with a drain electrode of the third switch tube, and a formed connecting line is provided with the first output end;
a source electrode of the second switch tube is connected with a drain electrode of the fourth switch tube, and a formed connecting line is provided with the second output end;
a drain electrode of the first switch tube is connected with a drain electrode of the second switch tube, and a formed connecting line is provided with a positive electrode connection point;
a source electrode of the third switch tube is connected with a source electrode of the fourth switch tube, and a formed connecting line is provided with a negative electrode connection point; and
respective grid electrodes of the first switch tube, the second switch tube, the third switch tube, and the fourth switch tube are connected with a sampling control circuit.

4. The inverter circuit according to claim 3, wherein:
the load circuit comprises a fifth switch tube, a sixth switch tube, a seventh switch tube, an eighth switch tube, a first capacitor, and a second capacitor;
a source electrode of the fifth switch tube is connected with a source electrode of the sixth switch tube;
a source electrode of the seventh switch tube is connected with a source electrode of the eighth switch tube;
a drain electrode of the sixth switch tube is connected with a first end of the first capacitor, and a formed connecting line is provided with the first output electrode;
a second end of the first capacitor is connected with a first end of the second capacitor;
a drain electrode of the eighth switch tube is connected with a second end of the second capacitor, and a formed connecting line is provided with the second output electrode;
respective grid electrodes of the fifth switch tube, the sixth switch tube, the seventh switch tube, and the eighth switch tube are connected with the sampling control circuit; and
a drain electrode of the fifth switch tube is connected with the third end of the first transformer, a drain electrode of the seventh switch tube is connected with the third end of the second transformer, the fourth end of the first transformer is connected with the fourth end of the second transformer, and a formed connection point and the load circuit are connected to a connecting line between the second end of the first capacitor and the first end of the second capacitor, or, the drain electrode of the fifth switch tube is connected with the fourth end of the first transformer, the drain electrode of the seventh switch tube is connected with the fourth end of the second transformer, the third end of the first transformer is connected with the third end of the second transformer, and a formed connection point and the load circuit are connected to the connecting line between the second end of the first capacitor and the first end of the second capacitor.

5. The inverter circuit according to claim 4, wherein:
the second output end of the H-bridge circuit is provided with a first current sensor;
when the third end of the first transformer is connected with the third end of the second transformer, or, when the fourth end of the first transformer is connected with the fourth end of the second transformer, a connecting line between the formed connection point and the load circuit is provided with a second current sensor;
the ground terminal of the H-bridge circuit is provided with a third current sensor;
the first current sensor, the second current sensor and the third current sensor are respectively connected with the sampling control circuit; and
the first current sensor is configured to sample oscillating current amplitude signals, the second current sensor is configured to sample respective current amplitude signals of the fifth switch tube, the sixth switch tube, the seventh switch tube, and the eighth switch tube, and the third current sensor is configured to sample total current amplitude signals when the first switch tube, the second switch tube, the third switch tube, and the fourth switch tube work.

6. The inverter circuit according to claim 5, wherein:
preset point positions sampled by the sampling control circuit comprise the first current sensor, the second current sensor, the third current sensor, the third end and the fourth end of the first transformer, the third end of the second transformer, the first end of the first capacitor, and the first end and the second end of the second capacitor; and
according to current or voltage signals of the preset point positions and power output requirements of the first output electrode and the second output electrode, the sampling control circuit outputs pulse width signals modulated according to waveform functions to control the first switch tube, the second switch tube, the third switch tube, and the fourth switch tube to work, and power pulse widths output by a forward transformer control the fifth switch tube, the sixth switch tube, the seventh switch tube, and the eighth switch tube to work as synchronous signals.

7. The inverter circuit according to claim 4, wherein the sampling control circuit is configured to:
generate pulse signals by changing modulation pulse width, modulation period, and phase-shifting time sequence according to respective current amplitude signals of the first switch tube, the second switch tube, the third switch tube, the fourth switch tube, the fifth switch tube, the sixth switch tube, the seventh switch tube and the eighth switch tube, current amplitude signals of the magnet oscillator circuit, sampling voltage amplitude signals of each point in the load circuit, and transmission power requirements for generating appointed waveform functions;
respectively output the pulse signals to the grid electrodes of the first switch tube, the second switch tube, the third switch tube and the fourth switch tube, so that the H-bridge circuit works circularly according to preset working mode; and
synchronously control the respective grid electrodes of the fifth switch tube, the sixth switch tube, the seventh switch tube, and the eighth switch tube according to pulse power time sequence output to the first transformer and the second transformer, so that the inverter circuit with two serially connected and alternating transformers works circularly, and the first transformer and the second transformer work alternately in the forward and flyback states to ensure that the first switch tube, the second switch tube, the third switch tube, the fourth switch tube, the fifth switch tube, the sixth switch tube, the seventh switch tube, and the eighth switch tube are in an on state when respective body diodes are switched on positively.

8. The inverter circuit according to claim 7, wherein:
the preset working mode comprises a first working mode, a second working mode, a third working mode, a fourth working mode, a fifth working mode, a sixth working mode, a seventh working mode, and an eighth working mode;
the first working mode is that the first switch tube and the fourth switch tube are in an on state, and the second switch tube and the third switch tube are in an off state;
in the first working mode, if the fifth switch tube and the sixth switch tube are in an off state, the first transformer is in the flyback state; if the seventh switch tube and the eighth switch tube are in the on state, the second transformer is in the forward state, and power is output to the load circuit through the second transformer; if the fifth switch tube and the sixth switch tube are in the on state, the first transformer is in the forward state, and the power is output to the load circuit through the first transformer; and the seventh switch tube and the eighth switch tube are in the off state, the second transformer is in the flyback state;
when the fifth switch tube and the sixth switch tube are in the on state, the first output electrode has a positive voltage; and when the seventh switch tube and the eighth switch tube are in the on state, the second output electrode has the positive voltage;
the second working mode is that the first switch tube is in the off state from the on state, the fourth switch tube keeps the on state, and the second switch tube and the third switch tube keep the off state;
in the second working mode, a freewheel characteristic of a primary inductor of a transformer in the flyback state of the first transformer and the second transformer in the first working mode causes the third switch tube to be switched on due to current passing through the body diode of the third switch tube, and the third switch tube is switched on when an voltage drop between the drain electrode and the source electrode of the third switch tube is equal to a positive voltage drop of the body diode of the third switch tube, at this time, the third switch tube is in the on state from the off state, freewheel loss of the body diode of the third switch tube is reduced, and the third working mode is achieved;
the third working mode is that the third switch tube and the fourth switch tube are in the on state, and the first switch tube and the second switch tube keep the off state;
in the third working mode, resonance current of the magnet oscillator circuit passes through the third switch tube and the fourth switch tube to form a closed loop;
the fourth working mode is that the fourth switch tube is in the off state from the on state, the third switch tube keeps the on state, and the first switch tube and the second switch tube keep the off state;
in the fourth working mode, freewheel characteristics of primary inductors of the first transformer and the second transformer cause the body diode of the second switch tube to be switched on for freewheeling, and the second switch tube is switched on when an voltage drop between the drain electrode and the source electrode of the second switch tube is equal to a positive voltage drop of the body diode of the second switch tube, at this time, the second switch tube is in the on state from the off state, freewheel loss of the body diode of the second switch tube is reduced, and the fifth working mode is achieved;
the fifth working mode is that the second switch tube and the third switch tube are in the on state, and the first switch tube and the fourth switch tube keep the off state;
in the fifth working mode, if the fifth switch tube and the sixth switch tube are in the off state, the first transformer is in the flyback state; and the seventh switch tube and the eighth switch tube are in the on state, the second transformer is in the forward state, and power is output to the load circuit through the second transformer; if the fifth switch tube and the sixth switch tube are in the on state, the first transformer is in the forward state, and the power is output to the load circuit through the first transformer; and the seventh switch tube and the eighth switch tube are in the off state, the second transformer is in the flyback state;
when the fifth switch tube and the sixth switch tube are in the on state, the first output electrode has a negative voltage; and when the seventh switch tube and the eighth switch tube are in the on state, the second output electrode has the negative voltage;
the sixth working mode is that the third switch tube is in the off state from the on state, the second switch tube keeps the on state, and the first switch tube and the fourth switch tube keep the off state;
in the sixth working mode, a freewheel characteristic of a primary inductor of a transformer in the flyback state of the first transformer and the second transformer in a previous working mode causes the body diode of the first switch tube to be switched on for freewheeling, and the first switch tube is switched on when an voltage between the drain electrode and the source electrode of the first switch tube is equal to a positive voltage of the body diode of the first switch tube, freewheel loss of the body diode of the first switch tube is reduced, and the seventh working mode is achieved;
the seventh working mode is that the first switch tube and the second switch tube are in the on state, and the third switch tube and the fourth switch tube keep the off state;
in the seventh working mode, resonance current of the magnet oscillator circuit passes through the first switch tube and the second switch tube to form a closed loop;
the eighth working mode is that the second switch tube is in the off state from the on state, the first switch tube keeps the on state, and the third switch tube and the fourth switch tube keep the off state; and
in the eighth working mode, freewheel characteristics of primary inductors of the first transformer and the second transformer cause the body diode of the fourth switch tube to be switched on for freewheeling, wherein the body diode of the fourth switch tube is switched on positively when the drain electrode and the source electrode of the fourth switch tube are in a zero-voltage state, freewheel loss of the body diode of the fourth switch tube is reduced, and the first working mode is achieved.

9. The inverter circuit according to claim 7, wherein a transformer in the flyback state of the first transformer and the second transformer is stored with oscillation energy, the oscillation energy is transmitted to the load circuit in a next alternating cycle, so that oscillation loss of the first transformer and the second transformer is a minimum, all power devices work in an optimal ultralow loss working condition, and the inverter circuit with two serially connected and alternating transformers is of extremely high transmission efficiency and has a transmitted power of more than 1.5 times of a single transformer in the forward state.

10. The inverter circuit according to claim 7, wherein:
when the first transformer or the second transformer works in the forward state or the flyback state and a voltage of the first output electrode is greater than that of the second output electrode, a sine wave output by the load circuit is in a positive half cycle, or, when the voltage of the first output electrode is smaller than that of the second output electrode, the sine wave output by the load circuit is in a negative half cycle, which is implemented by the fifth switch tube, the sixth switch tube, the seventh switch tube and the eighth switch tube being cooperated with time sequence of the first switch tube, the second switch tube, the third switch tube, and the fourth switch tube; and
the fifth switch tube and the sixth switch tube, as well as the seventh switch tube and the eighth switch tube, are switched on in echelons to achieve a bisynchronous rectification output characteristic, so that output powers of the first output electrode and the second output electrode present fluctuation characteristics of at least one function waveform of a sine function waveform, an exponential function waveform, a square wave function waveform, and a trigonometric function waveform according to a characteristic of pulse width modulation.

11. The inverter circuit according to claim 4, wherein:
the sampling control circuit is configured to adjust on time sequence of the fifth switch tube, the sixth switch tube, the seventh switch tube, and the eighth switch tube, so that the first transformer and the second transformer work alternately in the forward and flyback states, and are cooperated with the first switch tube, the second switch tube, the third switch tube, and the fourth switch tube so that the magnet oscillator circuit is in a complete resonance state during working;
when the first transformer is in the forward state, the second transformer is in the flyback state;
when the first transformer is in the flyback state, the second transformer is in the forward state; and
the complete resonance state is achieved by a primary inductor of a transformer in the flyback state in the first transformer or the second transformer and a resonant capacitor, and a transformer in the forward state of the first transformer or the second transformer is configured to transmit power.

12. The inverter circuit according to claim 4, wherein:
the sampling control circuit is configured to control on and off of the fifth switch tube, the sixth switch tube, the seventh switch tube, and the eighth switch tube so that the first transformer and the second transformer work alternately in the forward and flyback states;
when the fifth switch tube and the sixth switch tube are switched on and the seventh switch tube and the eighth switch tube are switched off, the first transformer is in the forward state to provide power, and the second transformer is in the flyback state with a magnetic core being charged and participating in resonance;
when the fifth switch tube and the sixth switch tube are switched off and the seventh switch tube and the eighth switch tube are switched on, the second transformer is in the forward state to provide power, and the first transformer is in the flyback state with a magnetic core being charged and participating in oscillation; and
when either the first transformer or the second transformer is in the flyback state, resonance occurs between a primary inductor of a transformer and a resonant capacitor.

13. The inverter circuit according to claim 12, wherein:
when the fifth switch tube and the sixth switch tube are in an on state, the seventh switch tube and the eighth switch tube are in an off state, the first transformer is in the flyback state, and output power current flows through the fifth switch tube and the sixth switch tube to charge the first capacitor;
when the fifth switch tube and the sixth switch tube are in the off state, the seventh switch tube and the eighth switch tube are in the on state, the second transformer is in the forward state, and output power current flows through the seventh switch tube and the eighth switch tube to charge the second capacitor;
switch time sequence of the fifth switch tube, the sixth switch tube, the seventh switch tube, and the eighth switch tube is consistent with an output pulse of a forward transformer;
when on cycles of the fifth switch tube and the sixth switch tube are consistent with those of the first switch tube and the fourth switch tube, a voltage of the first output electrode is greater than that of the second output electrode, so that the output voltage and current waveform of the load circuit are in a positive half cycle of alternating current; and
when on cycles of the fifth switch tube and the sixth switch tube are consistent with those of the second switch tube and the third switch tube, the voltage of the second output electrode is greater than that of the first output electrode, so that the output voltage and current waveform of the load circuit are in a negative half cycle of the alternating current.

14. The inverter circuit according to claim 13, wherein each of the fifth switch tube, the sixth switch tube, the seventh switch tube and the eighth switch tube is switched on, a tube voltage drop of the switch tube is clamped by a body diode of the switch tube, so that the body diode is in a positive on state every time when the switch tube is switched on, and then the switch tube is switched on with a minimum surge current value under a control of the sampling control circuit.

15. The inverter circuit according to claim 4, wherein, when a primary inductor of a transformer in the flyback state of the first transformer and the second transformer oscillates with a resonant capacitor, the sampling control circuit controls an on pulse width, PWM (Pulse-Width Modulation) period, dead time and phase time sequence of respective grid electrodes of the first switch tube, the second switch tube, the third switch tube, and the fourth switch tube, so that the first switch tube, the second switch tube, the third switch tube, and the fourth switch tube are in an on state when respective body diodes are switched on, and the magnet oscillator circuit is in a complete resonance state.

16. The inverter circuit according to claim 4, wherein:
when an alternating voltage output when a potential of the first output electrode is higher than that of the second output electrode is in a positive half cycle, an on time sequence of the fifth switch tube and the sixth switch tube is that the fifth switch tube is switched on, and then the sixth switch tube is in an on state from an off state after a body diode of the sixth switch tube is switched on, so that the sixth switch tube is in the on state when the body diode between the drain electrode and the source electrode is switched on positively, a counter current does not occur in the first capacitor, and the on fifth switch tube is switched on when working in a zero-voltage and zero-current state; and
when the alternating voltage output when the potential of the first output electrode is lower than that of the second output electrode is in a negative half cycle, the on time sequence of the fifth switch tube and the sixth switch tube is that the sixth switch tube is switched on, and then the fifth switch tube is in the on state from the off state after a body diode of the fifth switch tube is switched on, so that the fifth switch tube is in the on state when the body diode between the drain electrode and the source electrode has a positive voltage, a counter current does not occur in the first capacitor, and the on sixth switch tube is switched on when working in the zero-voltage and zero-current state.

17. The inverter circuit according to claim 4, wherein:
when the seventh switch tube and the eighth switch tube are switched on and when an alternating voltage output when a potential of the first output electrode is higher than that of the second output electrode is in a positive half cycle, an on time sequence of the seventh switch tube and the eighth switch tube is that the eighth switch tube is switched on, and then the seventh switch tube is in an on state from an off state after a body diode of the seventh switch tube is switched on, so that the seventh switch tube is in the on state when the body diode between the drain electrode and the source electrode has a positive voltage, a counter current does not occur in the second capacitor, and the on eighth switch tube is switched on when working in a zero-voltage and zero-current state; and
when alternating voltage output when the potential of the first output electrode is lower than that of the second output electrode is in a negative half cycle, the on time sequence of the seventh switch tube and the eighth switch tube is that the seventh switch tube is switched on, and then the eighth switch tube is in the on state from the off state after a body diode of the eighth switch tube is switched on, so that the eighth switch tube is working in the on state when the body diode between the drain electrode and the source electrode has a positive voltage, the counter current cannot occur in the second capacitor, and the on seventh switch tube is switched on in the zero-voltage and zero-current state.

18. The inverter circuit according to claim 4, wherein:
each of the first switch tube, the second switch tube, the third switch tube, the fourth switch tube, the fifth switch tube, the sixth switch tube, the seventh switch tube, and the eighth switch tube is an MOS (Metal Oxide Semiconductor) switch tube with a body diode; and
when the MOS switch tube is replaced with an IGBT (Insulated Gate Bipolar Transistor) switch tube with a body diode, a collector electrode of the IGBT switch tube corresponds to the drain electrode of the MOS switch tube, and an emitting electrode of the IGBT switch tube corresponds to the source electrode of the MOS switch tube.

19. An inverter equipment, comprising the inverter circuit according to claim 1.
